(19) United States
(12) Patent Application Publication
(10) Pub. No.: US 2016/0111201 A1
(43) Pub. Date: Apr. 21, 2016

(54) TRANSFORMER

(71) Applicant: Chicony Power Technology Co., Ltd., New Taipei City (TW)

(72) Inventors: Wen-Nan HUANG, New Taipei City (TW); Ching-Guo CHEN, New Taipei City (TW); Shiu-Hui LEE, New Taipei City (TW); Yao-Wen TSAI, New Taipei City (TW); HSIAO-CHIH KU, New Taipei City (TW)

(21) Appl. No.: 14/515,577

(22) Filed: Oct. 16, 2014

(51) Int. Cl. H01F 27/28; H01F 27/32; H01F 27/29; H01F 27/24

(52) U.S. Cl. CPC H01F 27/2823; H01F 27/24; H01F 27/325; H01F 27/29

(57) ABSTRACT

A transformer includes a bobbin, a primary winding set, a plurality of secondary winding sets, and a magnetic core. The bobbin includes a winding part. The primary winding set is wound on the winding part. The secondary winding sets twist together and are wound on the winding part for uniform leakage inductance in secondary winding sets of the transformer. The magnetic core is assembled with the bobbin. The magnetic core, the primary winding set, and the twisted secondary winding sets collectively achieve function of power conversion.

### BACKGROUND OF THE INVENTION

1. Field of the Invention

The present invention relates to a transformer, and in particular to a transformer with uniform leakage inductance in secondary winding sets.

2. Description of Related Art

Modern life is full of a variety of electronic devices. Transformer is an indispensable accessory for modulating voltage level to be suitable for the electronic devices.

Reference is made to FIG. 1 and FIG. 2. A related art transformer shown in FIG. 2 is applied to a power converting system with LLC resonant circuit shown in FIG. 1. The transformer 100 includes a bobbin 102, a primary winding set 104, first secondary winding set 106, and a second secondary winding set 108. The primary winding set 104 is wound on a winding part of the bobbin 102, the first secondary winding set 106 is wound overlapping the primary winding set 104, and the second secondary winding set 108 is wound overlapping the first secondary winding set 106. The transformer 100 further includes a magnetic core 110 for generating electromagnetic induction with the first secondary winding set 106 and the second secondary winding set 108, so that the first secondary winding set 106 and the second secondary winding set 108 respectively generate an output voltage. The difference between turns of the primary winding set 104 and that of the secondary winding sets 106 and 108 makes different voltage gain outputting from the first secondary winding set 106 and the second secondary winding set 108, which achieves purpose of power conversion.

However, when the transformer 100 generates electric power conversion, leakage inductance is distributed throughout the primary winding set 104, the first secondary winding set, and the second secondary winding 106 and 108 because of the flux setup by the primary winding set 104 does not couple well the first secondary winding set 106 and the second secondary winding set 108.

When the transformer shown in FIG. 1 is applied to a power converting system having LLC resonant circuit operated under high-frequency condition (operating frequency over 500 KHz), since the second secondary winding set 108 is wound overlapping the first secondary winding 108, the distance between the first secondary winding set 106 and the magnetic core 110 is different from the distance between the second secondary winding set 108 and the magnetic core 110, so that the flux setup by the primary winding set 104 links the first secondary winding set 106 and the second secondary winding set 108 are different, which causes the first secondary winding set 106 and the second secondary winding set 108 have various leakage inductances, and then the power converting system has poor operating efficiency, higher output ripple, and unbalance electric power energy.

### SUMMARY OF THE INVENTION

The object of the present invention is to provide a transformer, which has uniform leakage inductance of secondary winding sets of the transformer when the transformer is applied to an LLC circuit operated under high-frequency condition.

Accordingly, the present invention provides a transformer comprises a bobbin, a primary winding set, a plurality of secondary winding sets, and a magnetic core. The bobbin includes a winding part, first pins, and second pins. The bobbin further comprises a bottom, the first pins are mounted on a side of the bottom, and the second pins are mounted on the bottom and opposite to the first pins. In the present invention, the amount of the first pins and the second pins are respectively two and four.

The primary winding set is wound on the winding part, and an initial end and a terminal end of the primary winding set are respectively connected to the first pins. The primary winging set is, for example, solid core cable or stranded cable. The secondary winding sets twist together and wound overlapping the primary winding set. The secondary winding sets are, for example, a multi-conductors cable or a stranded cable. In the present invention, the amount of the secondary winding sets is, for example, two, and an initial end and a terminal end of each of the secondary winding sets are respectively connected to the second pins. The magnetic core is assembled with the bobbin.

The transformer may further comprise an isolating member arranged between the primary winding set and the secondary winding sets for spacing the first winding set and the second winding sets. The isolating member is, for example, tape and used for isolating the primary winding set and the secondary winding sets.

The leakage inductance in secondary winding sets of the transformer of the present invention can be uniformed and then reduce output ripple and balance output energies when the transformer is applied to a power converting system with LLC resonant circuit operated under high-frequency condition due to the secondary winding sets twist together and are wound overlapping the primary winding set wound on the winding part.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a circuit diagram of a power converting system having LLC resonant circuit.

FIG. 2 shows a related art transformer.

FIG. 3 is a sectional view of a transformer according to a first embodiment of the present invention.

FIG. 4 is a top view of assembled bobbin, primary winding set, and secondary winding sets according to the present invention.

FIG. 5 is a side view of assembled bobbin, primary winding set, and secondary winging sets according to the first embodiment of the present invention.

FIG. 6 is a schematic view of the secondary winding sets according to the first embodiment of the present invention.

FIG. 7 is a sectional view of a transformer according to a second embodiment of the present invention.

FIG. 8 is a side view of assembled bobbin, primary winding set, and the second winding sets according the second embodiment of the present invention.

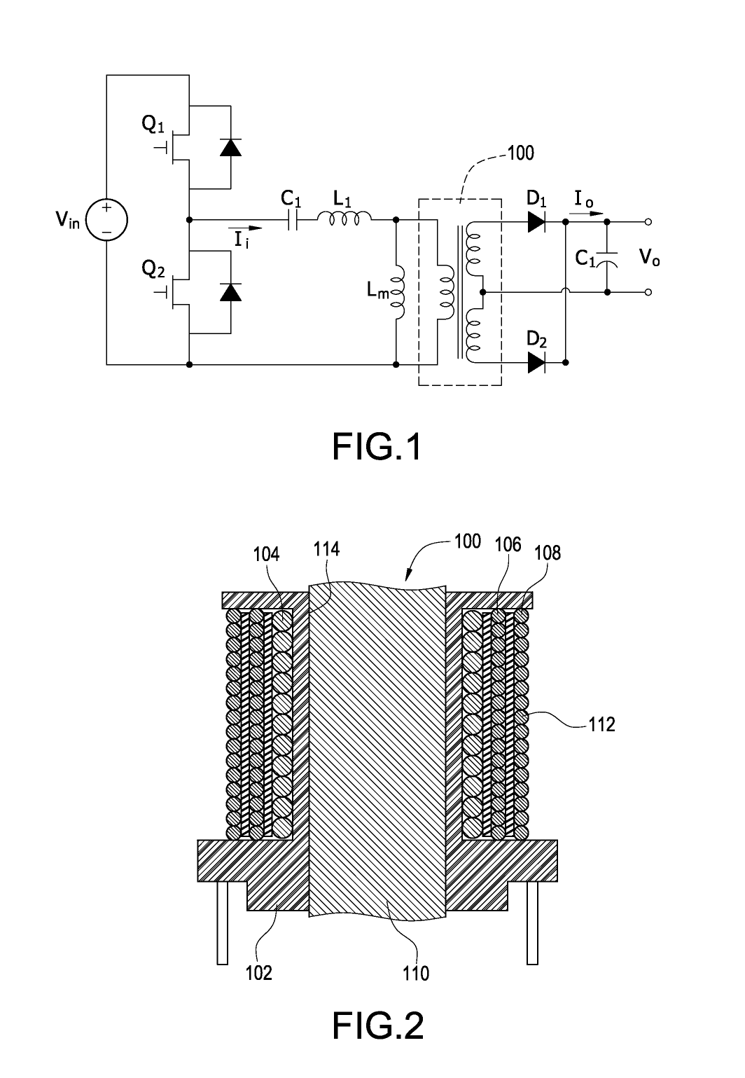

### DETAILED DESCRIPTION OF THE INVENTION

A preferred embodiment of the present invention will be described with reference to the drawings.

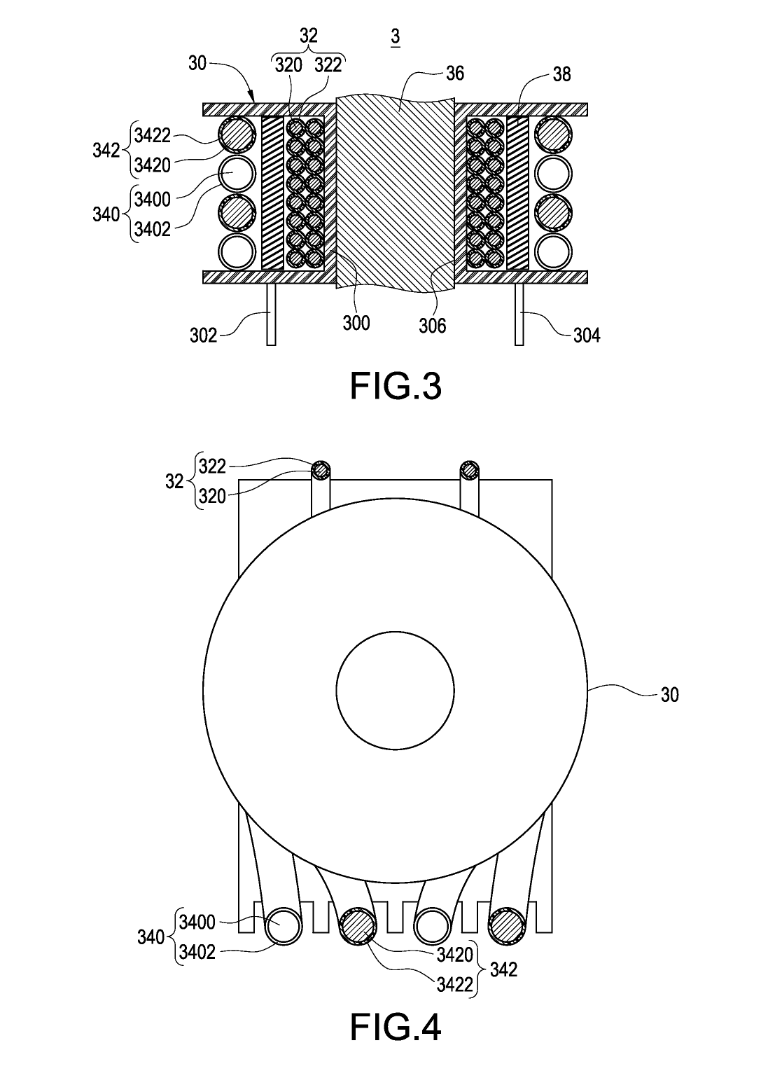

Reference is made to FIG. 3, which is a sectional view of a transformer according to a first embodiment of the present invention. The transformer 3 includes a bobbin 30, a primary winding set 32, a plurality of secondary winding sets 340 and 342, and a magnetic core 36. Reference is made to FIG. 4, which is a top view of assembled bobbin, primary winding set, and secondary winding sets according to the first embodiment of the present invention. The bobbin 30 is made of material with electric insulativity and includes a winding part 300, a plurality of first pins 302, and a plurality of second pins 304. A through hole 306 penetrating through the winding part 300 allowing a part of the magnetic core 36 accommodating therein when the magnetic core 36 is assembled with the bobbin 30.

The first pins 302 are mounted on a bottom of the winding part 300, and in particularly, the first pins 302 are mounted on a side of the bottom. The second pins 302 are mounted on the bottom of the winding part 300 and opposite to the first pins 302. In this embodiment, the bobbin 30 includes two first pins 300 and four second pins 302, the amount of the first pins 300 and the second pins 302, however, may be modified according to particular demand.

The primary winding set 32 is a solid core cable or stranded cable. In particularly, the solid core cable includes one solid wire (such as bare copper wire) and an isolating cover or three layers isolating cover wrapped around the solid wire, so as to space the primary winding set 32 and the secondary winding sets 340 and 342 and prevent the primary winding set 32 and the secondary winding sets 340 and 342 from interference. In this embodiment, the primary winding set 32 includes one solid wire 320 and one layer isolating cover 322 wrapped around the solid wire 320. The primary winding set 32 is wound on the winding part 300 in S-shaped, an initial end of the primary winding set 32 is connected to one of the first pins 302, and a terminal end of the primary winding set 32 is connected to the other first pin 302.

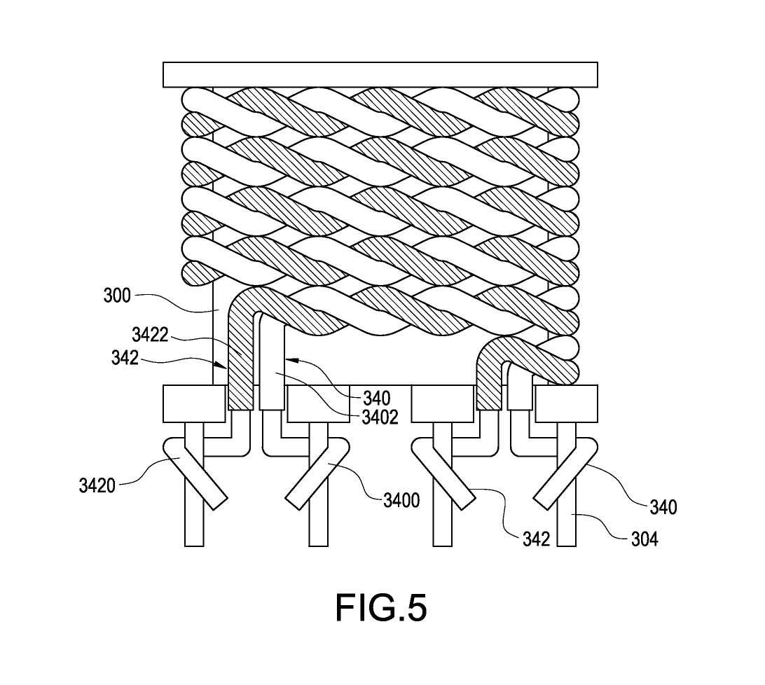

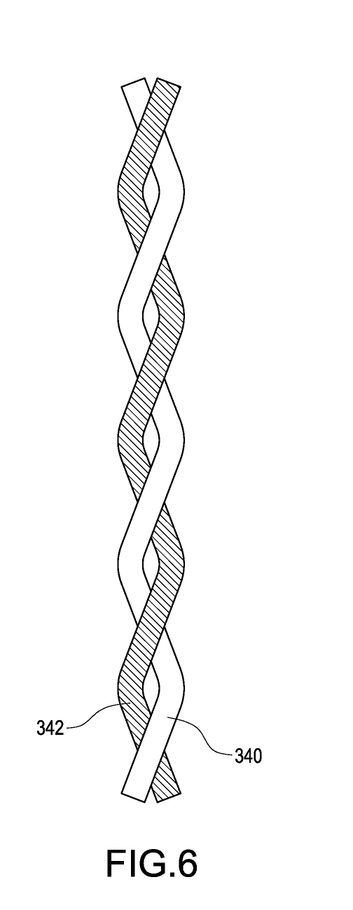

The secondary winding sets 340 and 342 are respectively a solid core cable or a stranded cable. As shown in FIG, 3 and FIG. 4, the transformer 3 includes two secondary winding sets 340 and 342, and the secondary winding sets 340 and 342 are respectively a single conductor cable. In the other words, the secondary winding set 340 includes one solid wire 3400 (such as bare copper wire) and an isolating cover 3402 wrapped around the solid wire 3400, and the secondary winding set 342 includes one solid wire 3420 and an isolating cover 3422 wrapped around the solid wire 3420. The secondary winding sets 340 and 342 twist together and form a stranded cable (as shown in FIG. 6). The secondary winding sets 340 and 342 are wound overlapping the primary winding set 32 in S-shaped, and internal ends of the secondary windings 340 and 342 are respectively connected to one of the second pins 304 (as shown in FIG. 5), and the terminal ends of the secondary windings 340 and 342 are respectively connected to the other second pins 304.

An isolating member 38 is arranged between the primary winding set 32 and the secondary winding sets 340 and 342. The isolating member 38 is, for example, tape, and user for isolating the primary winding set 32 and the secondary winding sets 340 and 342 from interference.

The magnetic core 36 is assembled with the bobbin 30, and a magnetic pillar of the magnetic core penetrates the through hole 306 formed on the bobbin 30. The magnetic core 36 is made of magnetic material, and the magnetic core 36 is of E-shape, ATQ shape, ER shape, ERI shape, ECI shape, RM shape, EQ shape, PQ shape, PJ shape, or PM shape.

When and external electric power inputted from the first pins 302 of the transformer 3, the primary winding set 32 receives the external electric power, and generates inductance with secondary winding sets 340 and 342 through the magnetic core 36, thereby generate electric power conversion, finally output through the secondary winding sets 340 and 342. In the other words, the secondary winding sets 340 and 342 generate magnetic coupling with the primary winding set 32 through the magnetic core 36 so that the transformer 3 has the function of voltage level transformation.

In order to uniform leakage inductance of the secondary winding sets 340 and 342 of the transformer 3 applied to power converting system having an LLC resonant circuit and operated under high-frequency condition, the secondary winding sets 340 and 342 twist together. In this matter, a distance between the secondary winding set 340 and the magnetic core 36 equals to a distance between the secondary winding set 342 and the magnetic core 36, and the magnetic flux passing through the secondary winding set 340 equals to that passing through the secondary winding set 342, thereby the leakage inductance of the secondary winding sets 340 and 342 are uniform.

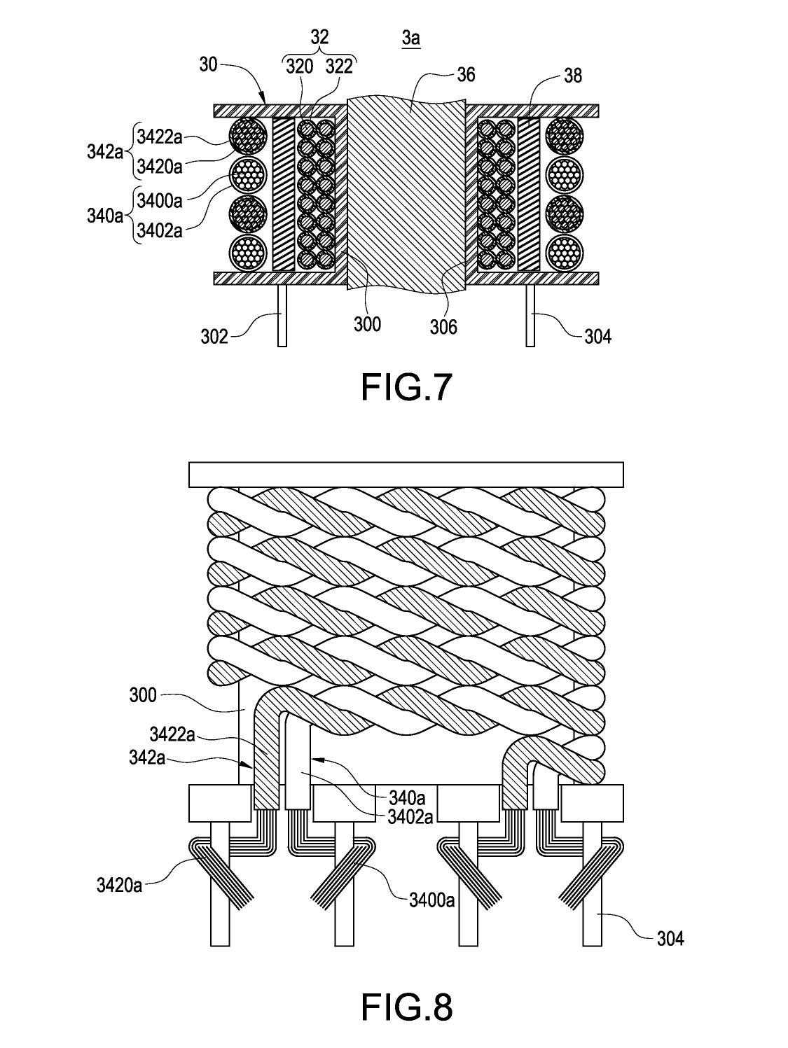

Reference is made to FIG. 7 and FIG. 8, which are respectively a sectional view and a side view of a transformer according to a second embodiment of the present invention. The transformer 3a is similar to that of first embodiment mentioned above, and wherever possible, the reference numbers are used in the drawings and the description to refer to the same parts. What deserves to be mentioned is that secondary winging sets 340a and 342a are respectively stranded cable. The current capacity of the stranded cable is higher than that of the solid core cable. The stranded cable can reduce skin effect causing current flowing mainly at the skin of the conductor when the transformer 3a is operated under high-frequency condition. The secondary winding set 340a is composed of a number of small gauge wires 3400a bundled or wrapped together to form a larger conductor and an insulated cover 3402a wraps the wire 3400a, and the secondary winding set 342a is composed of a number of small gauge wires 3420a bundled or wrapped together to form a larger conductor and an insulated cover 3422a wraps the wire 3420a.

The secondary winding sets 340a and 342a are wound overlapping the primary winding set 32 in S-shaped, and internal ends of the secondary windings 340 and 342 are respectively connected to one of the second pins 304, and the terminal ends of the secondary windings 340 and 342 are respectively connected to the other second pins 304. It should be noted that the wires 3400a of the secondary winding set 340a are connected to one of the second pins 304, and the wires 3420a are connected to another second pins 304, as shown in FIG, 7. The current carrying capacity of the secondary winding sets 340a are 342a are respectively increased since the wires 3400a and 3402a can respectively conduct current, thereby the effective resistance of the wires 3400a and 3420a is reduced when the secondary winding sets is operated under high-frequency condition, and then current loss is reduced.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

1. A transformer comprising:
a bobbin comprising a winding part;
a primary winding set wound on the winding part;
a magnetic core assembled with the bobbin; and
a plurality of secondary winding sets twisted together and wound on the winding part, wherein a distance between one of the secondary winding sets and the magnetic core is equal to a distance between the other secondary winding set and the magnetic core.

2. The transformer in claim 1, wherein the secondary winding set is wound overlapping the primary winding set.

3. The transformer in claim 1, further comprises an isolating member located between the primary winding set and the secondary winding sets to space the first winding set and the secondary winding sets.

4. The transformer in claim 1, wherein the bobbin further comprises a bottom, a plurality of first pins and a plurality of second pins, the first pins are mounted on a side of the bottom and the second pins are mounted on the opposite side of the bottom, an initial end and a terminal end of the primary winding set are respectively connected on the first pins, and an initial end and a terminal end of the secondary winding sets are respectively connected on the second pins.

5. The transformer in claim 4, wherein the secondary winding sets are wound overlapping the primary winding set wound on the winding part.

6. The transformer in claim 5, further comprising an isolating member located between the primary winding set and the secondary winding sets to space the primary winding set and the secondary winding sets.

7. The transformer in claim 1, wherein the primary winding set is a solid core cable or a stranded cable.

8. The transformer in claim 1, wherein the secondary winding sets are respectively a multi-conductors cable or a stranded cable.

9. The transformer in claim 1, wherein the magnetic core is of E-shape, ATQ shape, ER shape, ERI shape, ECI shape, RM shape, EQ shape, PQ shape, PJ shape, or PM shape.
